(19) United States
(12) Patent Application Publication
(10) Pub. No.: US 2007/0076436 A1
(43) Pub. Date: Apr. 5, 2007

(54) Backlight module having improved light utilization ratio and liquid crystal having same

(75) Inventors: Xiao-Ping Ma, Shenzhen (CN); Wei Shu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/541,226

(22) Filed: Sep. 29, 2006

(30) Foreign Application Priority Data
Sep. 30, 2005 (TW) 94134293

(51) Int. Cl. F21V 19/00

(52) U.S. Cl. 362/634; 362/614

(57) ABSTRACT

An exemplary backlight module (3) includes a light guide plate (31), a light source (32) located adjacent to the light guide plate and a fixing member (33) located adjacent to a corner of the light guide plate. The light source includes a corner portion. The fixing member includes a channel (332) fixedly receiving the corner portion of the light source, and a light transmission cutout (334) defined through an inner wall thereof. The light transmission cutout communicates with the channel. Light beams emitting from the corner portion of the light source can enter the light guide plate via the light transmission structure. Therefore, the backlight module has a high light utilization ratio and a uniform brightness distribution.

### FIELD OF THE INVENTION

The present invention relates to backlight modules typically used in liquid crystal displays (LCDs), and particularly to a backlight module having a light source fixing member that can give the backlight module an improved light utilization ratio.

### GENERAL BACKGROUND

A typical liquid crystal display is capable of displaying a clear and sharp image through millions of pixels that make up the complete image. The liquid crystal display has thus been applied to various electronic equipment in which messages or pictures need to be displayed, such as mobile phones and notebook computers. However, liquid crystals in the liquid crystal display do not themselves emit light. Rather, the liquid crystals have to be lit up by a light source so as to clearly and sharply display text and images. The light source may be ambient light, or a backlight module attached to the liquid crystal display.

Referring to FIG. 8, a typical backlight module 1 generally includes a light guide plate 11, a light source 12, and a fixing block 13. The light guide plate 11 is a substantially rectangular sheet, and includes two generally adjacent light incident surfaces 111 and a light emission surface 112 substantially perpendicular to the two incident surfaces 111. The fixing block 13 is located next to a rounded corner of the light guide plate 11 defined between the two incident surfaces 111. The light source 12 is L-shaped, thus defining a corner portion (not labeled) thereof. The corner portion of the light source 12 is rounded, and corresponds in shape to the rounded corner of the light guide plate 11. Referring also to FIG. 9, the light source 12 is located adjacent to the two incident surfaces 112 of the light guide plate 11, with the corner portion fixed in a curved fixing channel 132 defined in the fixing block 13.

The fixing block 13 includes a top surface, a rounded side surface 133 corresponding to the rounded corner of the light guide plate 11, and the fixing channel 132 defined at the top surface 131. The fixing channel 132 receives the corner portion of the light source 12 and thereby fixes the light source 12 relative to the light guide plate 11. If the backlight module 1 is subject to shock or jarring, the fixing block 13 prevents the light source 12 from moving toward and colliding with the light guide plate 11.

However, light emitted from the corner portion of the light source 12 is obstructed by the fixing block 13 and cannot enter the light guide plate 11. This means that the brightness of a corner of the backlight module 1 corresponding to the rounded corner of the light guide plate 11 is apt to be reduced. Moreover, the light blocked by the fixing block 13 is converted into heat, and the temperature in the vicinity of the rounded corner of the light guide plate 11 tends to be elevated. The backlight module 1 commonly also includes one or more optical films disposed adjacent the light emission surface 112 of the light guide plate 11. In such case, portions of the optical films adjacent to the rounded corner of the light guide plate 11 may be warped by the elevated temperatures prevailing thereat. For these reasons, optical characteristics of the backlight module 1 may be degraded, and the quality of images provided by an associated liquid crystal display may be impaired.

Therefore, a new backlight module and a liquid crystal display that can overcome the above-described problems are desired.

### SUMMARY

In a preferred embodiment, a backlight module includes a light guide plate, a light source located adjacent to the light guide plate, and a fixing member located adjacent to a corner of the light guide plate. The light source includes a corner portion. The fixing member includes a channel fixedly receiving the corner portion of the light source, and a light transmission cutout defined through an inner wall thereof. The light transmission cutout communicates with the channel.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a side view of a liquid crystal display according to a first embodiment of the present invention, the liquid crystal display including a backlight module.

FIG. 2 is an exploded, isometric view of the backlight module of the liquid crystal display of FIG. 1, the backlight module including a fixing block.

FIG. 3 is an enlarged view of the fixing block of FIG. 2.

FIG. 4 is an isometric view of a second embodiment of a fixing block of the present invention.

FIG. 5 is an isometric view of a third embodiment of a fixing block of the present invention.

FIG. 6 is an isometric view of a fourth embodiment of a fixing block of the present invention.

FIG. 7 is an exploded, isometric view of a backlight module according to a second embodiment of the present invention.

FIG. 8 is an exploded, isometric view of a conventional backlight module, the backlight module including a fixing block.

FIG. 9 is an enlarged, isometric view of the fixing block of the backlight module of FIG. 8.

### DETAILED DESCRIPTION OF PREFERRED EMBODIMENTS

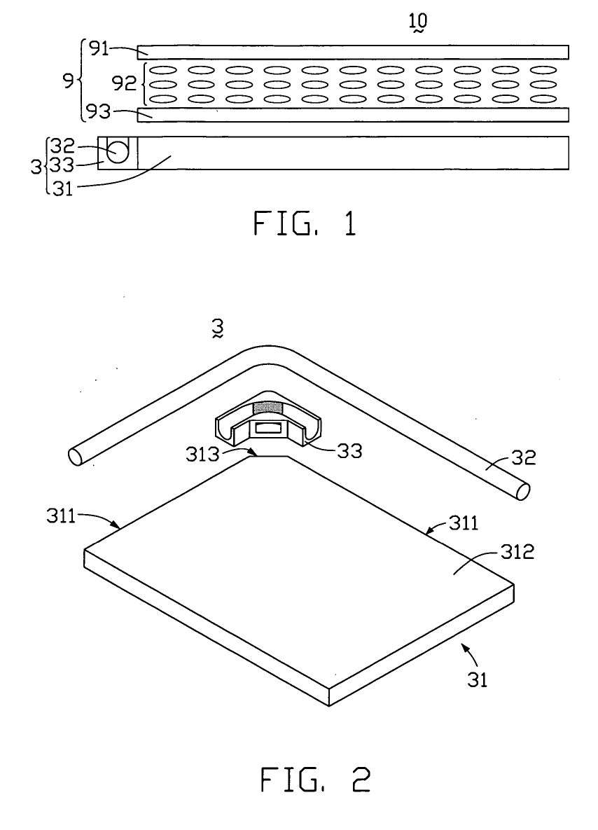

Referring to FIG. 1, a liquid crystal display 10 according to a first embodiment of the present invention includes a liquid crystal panel 9, and a backlight module 3 for illuminating the liquid crystal panel 9. The liquid crystal panel 9 includes an upper substrate 91, a lower substrate 93 opposite to the upper substrate 91, and a liquid crystal layer 92 sandwiched between the upper and lower substrates 91, 93. The backlight module 3 is located adjacent to the lower substrate 93.

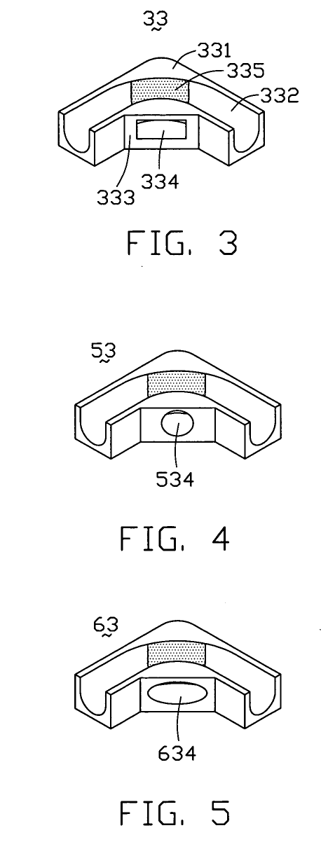

Referring also to FIG. 2, the backlight module 3 includes a light guide plate 31, a light source 32, and a fixing block 33. The light guide plate 31 is a substantially rectangular sheet, and includes two generally adjacent light incident surfaces 311 and a light emission surface 312 substantially perpendicular to the two incident surfaces 311. The fixing block 33 is located opposite to an oblique corner surface 313 defined between the two incident surfaces 311. The light source 32 is L-shaped, thus defining a corner portion (not labeled) thereof. Referring also to FIG. 3, the light source 32 is located adjacent to the two incident surfaces 312 of the light guide plate 31, with the corner portion of the light source 32 fixed in a curved fixing channel 332 defined in the fixing block 33. The light source 32 may be a cold cathode fluorescent lamp (CCFL).

The fixing block 33 includes a top surface 331, the fixing channel 332 defined at the top surface 331, and three inner side surfaces 333 which connect with each other. A middle one of the side surfaces 333 is located adjacent to the corner surface 313 of the light guide plate 31. A rectangular light transmission hole 334 is defined through an inner wall of the fixing block 33 at the middle side surface 333, the light transmission hole 334 communicating with the fixing channel 332. A reflective film 335 is formed at an inner surface of the fixing block 33 in the fixing channel 332, opposite to the light transmission hole 334. The fixing block 33 may be made of an elastic material, such as rubber. The reflective film 335 may be made from silver or aluminum.

Light beams emitting from part of the corner portion of the light source 32 enter the light guide plate 31 via the light transmission hole 334 and the corner surface 313. Other light beams emitting from part of the corner portion of the light source 32 are reflected by the reflective film 335, and then enter the light guide plate 31 via the corner portion of the light source 32, the light transmission hole 334 and the corner surface 313. Therefore, the backlight module 3 has an improved light utilization ratio and enhanced uniform brightness distribution over the whole emission surface 312 of the light guide plate 31. Moreover, because blockage of light emitting from the corner portion of the light source 32 is reduced, buildup of excessive heat in and around the corner surface 313 of the light guide plate 31 can be avoided. That is, the backlight module 3 can provide satisfactory and timely dissipation of any heat produced by the corner portion of the light source 32. Thus if the backlight module 3 also includes one or more optical films adjacent the light emission surface 312 of the light guide plate 31, warping of the optical films can be avoided.

FIG. 4 shows a second embodiment of a fixing block of the present invention. The fixing block 53 is similar to the fixing block 33 of the first embodiment. However, the fixing block 53 has a circular light transmission hole 534.

FIG. 5 shows a third embodiment of a fixing block of the present invention. The fixing block 63 is similar to the fixing block 33 of the first embodiment. However, the fixing block 63 has an elliptic light transmission hole 634.

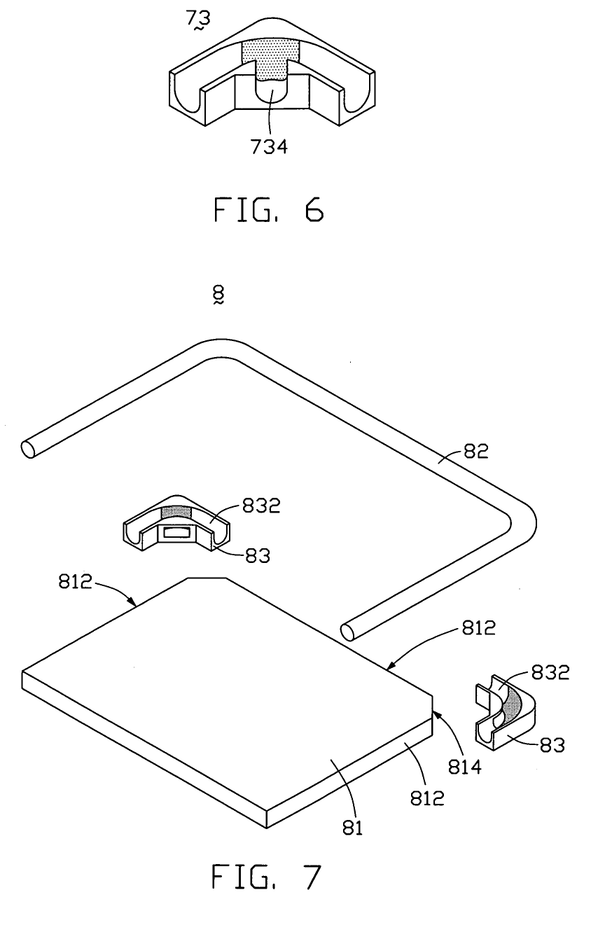

FIG. 6 shows a fourth embodiment of a fixing block of the present invention. The fixing block 73 is similar to the fixing block 33 of the first embodiment. However, the fixing block 73 has a light transmission cutout 734.

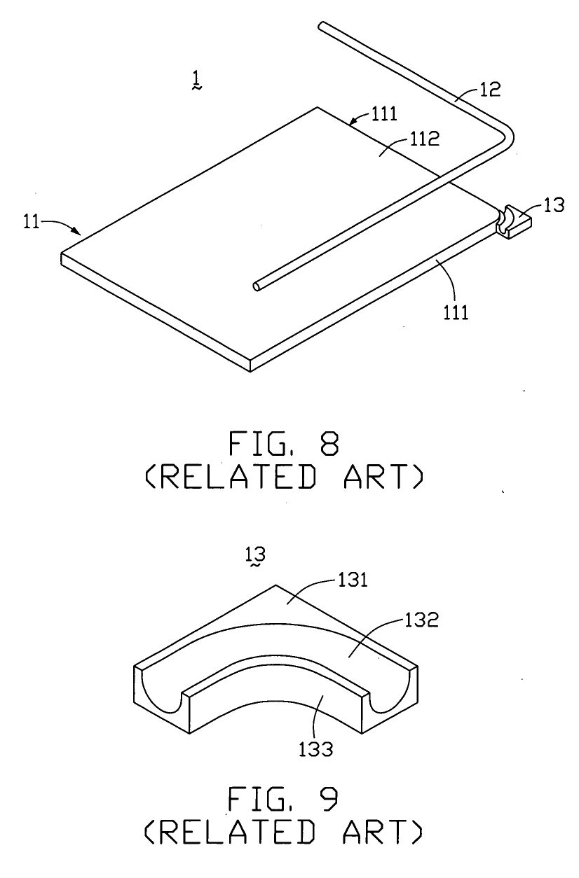

Referring to FIG. 7, a backlight module 8 according to a second embodiment of the present invention includes a light guide plate 81, a light source 82, and two fixing blocks 83. The light guide plate 81 includes three consecutive generally adjacent light incident surfaces 812, and two oblique corner surfaces 814 defined between the three incident surfaces 812 respectively. The light source 82 is generally U-shaped, thus defining two corner portions (not labeled) thereof. Each fixing block 83 has substantially the same structure as that of the fixing block 33 of the first embodiment. The light source 82 is disposed adjacent to the three consecutive incident surfaces 812, with the two corner portions of the light source 82 fixed in fixing channels 832 of the fixing blocks 83 respectively.

In alternative embodiments, a transparent resin or other suitable transparent material may be filled in the light transmission hole or the light transmission cutout.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate;
a light source located adjacent to the light guide plate and having a corner portion; and
a fixing member located adjacent to a corner of the light guide plate, the fixing member comprising a channel fixedly receiving the corner portion of the light source, and further comprising a light transmission cutout defined through an inner wall thereof, the light transmission cutout communicating with the channel.

2. The backlight module as claimed in claim 1, wherein the light source includes a cold cathode fluorescent lamp (CCFL).

3. The backlight module as claimed in claim 1, wherein the fixing member is made of rubber.

4. The backlight module as claimed in claim 1, wherein the light source is substantially L-shaped.

5. The backlight module as claimed in claim 1, further comprising a reflective film provided at an inner surface of the fixing block in the channel, opposite to the light transmission cutout.

6. The backlight module as claimed in claim 1, wherein a transparent material is filled in the light transmission cutout.

7. The backlight module as claimed in claim 6, wherein the transparent material is a transparent resin.

8. The backlight module as claimed in claim 1, wherein the light transmission cutout is a rectangular, circular, or elliptic hole.

9. The backlight module as claimed in claim 1, further comprising another fixing member located adjacent to another corner of the light guide plate, wherein the light source is substantially U-shaped and has another corner portion, and said another fixing member comprises a channel fixedly receiving said another corner portion of the light source, and further comprises a light transmission cutout defined through an inner wall thereof, the light transmission cutout communicating with the channel.

10. A liquid crystal display comprising:
a liquid crystal panel; and
a backlight module adjacent the liquid crystal panel for illuminating the liquid crystal panel, the backlight module comprising:
a light guide plate;
a light source located adjacent to the light guide plate and having a corner portion; and
a fixing member located adjacent to a corner of the light guide plate, the fixing member comprising a channel fixedly receiving the corner portion of the light source, and further comprising a light transmission cutout defined through an inner wall thereof, the light transmission cutout communicating with the channel.

11. The liquid crystal display as claimed in claim 10, wherein the light source includes a cold cathode fluorescent lamp.

12. The liquid crystal display as claimed in claim 10, wherein the fixing member is made of rubber.

13. The liquid crystal display as claimed in claim 10, wherein the light source is substantially L-shaped.

14. The liquid crystal display as claimed in claim 10, further comprising a reflective film provided at an inner surface of the fixing block in the channel, opposite to the light transmission cutout.

15. The liquid crystal display as claimed in claim 10, wherein a transparent material is filled in the light transmission cutout.

16. The liquid crystal display as claimed in claim 15, wherein the transparent material is a transparent resin.

17. The liquid crystal display as claimed in claim 10, wherein the light transmission cutout is a rectangular, circular, or elliptic hole.

18. The liquid crystal display as claimed in claim 10, further comprising another fixing member located adjacent to another corner of the light guide plate, wherein the light source is substantially U-shaped and has another corner portion, and said another fixing member comprises a channel fixedly receiving said another corner portion of the light source, and further comprises a light transmission cutout defined through an inner wall thereof, the light transmission cutout communicating with the channel.

19. A backlight module comprising:
a light guide plate;
a light source located adjacent to the light guide plate and having a corner portion; and
a fixing member located adjacent to a corner of the light guide plate, the fixing member comprising a channel fixedly receiving the corner portion of the light source, and further comprising a light transmission cutout configured for allowing light beams emitted from the corner portion of the light source to transmit therethrough to the light guide plate.
